(19) United States
(12) Patent Application Publication
(10) Pub. No.: US 2024/0402128 A1
(43) Pub. Date: Dec. 5, 2024

(54) QCM SENSOR

(71) Applicant: Inficon Inc., East Syracuse, NY (US)

(72) Inventors: Joel A. Furco, Baldwinsville, NY (US); Russ Bench, Cicero, NY (US)

(73) Assignee: Inficon Inc., East Syracuse, NY (US)

(21) Appl. No.: 18/678,462

(22) Filed: May 30, 2024

Related U.S. Application Data
(60) Provisional application No. 63/469,570, filed on May 30, 2023.

(51) Int. Cl. G01N 29/02; G01N 29/22

(52) U.S. Cl. CPC G01N 29/022; G01N 29/222

(57) ABSTRACT

A quartz crystal microbalance (QCM) sensor, comprises a sensor housing and a crystal component supported within the sensor housing. The crystal component includes a quartz crystal substrate and a gasket seal disposed about the periphery of the quartz crystal substrate configured to prevent ingress of fluids into the sensor housing.

The present application claims the benefit of and priority to U.S. provisional Application Ser. No. 63/469,570, filed May 30, 2023, the entire contents of which are hereby incorporated by reference herein.

### 1. TECHNICAL FIELD

The present invention relates to a quartz crystal microbalance (QCM) sensor, and, more particularly, relates to a QCM sensor including a quartz crystal component having a quartz substrate and a gasket seal secured about the periphery of the quartz substrate.

### 2. BACKGROUND OF THE INVENTION

A QCM sensor generally includes a quartz crystal with a pair of electrodes, a holder or sensor body which supports the quartz crystal, an oscillator for driving the crystal and a monitor for monitoring activity associated with one or more film deposition processes. In thin film applications where QCM sensors are used, the inside of the sensor body may not be adequately sealed from the film or deposition processes. The insufficiency or lack of seal provides multiple paths of ingress of deposited film material or other environmental contaminants into the sensor body, which could cause an electrical short or an electrical discontinuity to occur.

### 3. SUMMARY

Accordingly, the present disclosure is directed to a QCM sensor including a sensor body and a quartz crystal. The quartz crystal incorporates a seal which is integrally formed with the crystal body. The seal isolates the sensor body and prevents migration of deposition, film and/or any other contaminants inside the sensor body and the back end of the quartz crystal oscillator. Thus, a seal is formed around the quartz crystal substrate itself and on both sides of the substrate.

In one illustrative embodiment, a quartz crystal microbalance (QCM) sensor comprises a sensor housing and a crystal seal component supported within the sensor housing. The crystal seal component includes a quartz crystal substrate (i.e., the oscillating plate) and a gasket seal disposed about the periphery of the crystal substrate configured to prevent ingress of fluids into the sensor housing.

In embodiments, the sensor housing includes a crystal holder for at least partially supporting the crystal seal component and a sensor body coupled to the crystal holder. The gasket seal is disposed between the crystal holder and the sensor body.

In certain embodiments, the gasket seal extends from the back and rear surfaces of the crystal substrate.

In embodiments, the gasket seal is overmolded onto the crystal substrate.

In some embodiments, an interference fit between components of the sensor housing, the gaskets seal and/or combinations thereof forms or assists in forming the desired scaling relation within the sensor body.

In some embodiments, the gasket seal if comprised of a perfluoroelastomer material selected to withstand the temperature parameters of the process environment.

In some embodiments, the perfluoroelastomer material is selected to be chemically resistant to corrosive elements present in the process environment.

In some embodiments, gasket seal is wrapped around and isolates the crystal component from external vibration sources in the process environment.

In some embodiments, the crystal holder is coated with a chemically resistant protective coating which may be comprised of silica, alumina, or a combination of silica and alumina.

In embodiments, the quartz crystal microbalance (QCM) sensor may be coated with a chemically resistant protective coating which may be comprised of silica, alumina, or a combination of silica and alumina.

### 4. BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 is a side cross-sectional view of a prior art QCM sensor;

FIG. 2 is a perspective view of the crystal seal component of the QCM sensor in accordance with one or more illustrative embodiments of the present disclosure;

FIG. 3 is a perspective view in partial cross-section crystal seal component of the QCM sensor in accordance with one or more illustrative embodiments of the present disclosure; and

FIG. 4 is a side cross-sectional view of the QCM sensor in accordance with one or more illustrative embodiments of the present disclosure.

### 5. DETAILED DESCRIPTION OF THE INVENTION

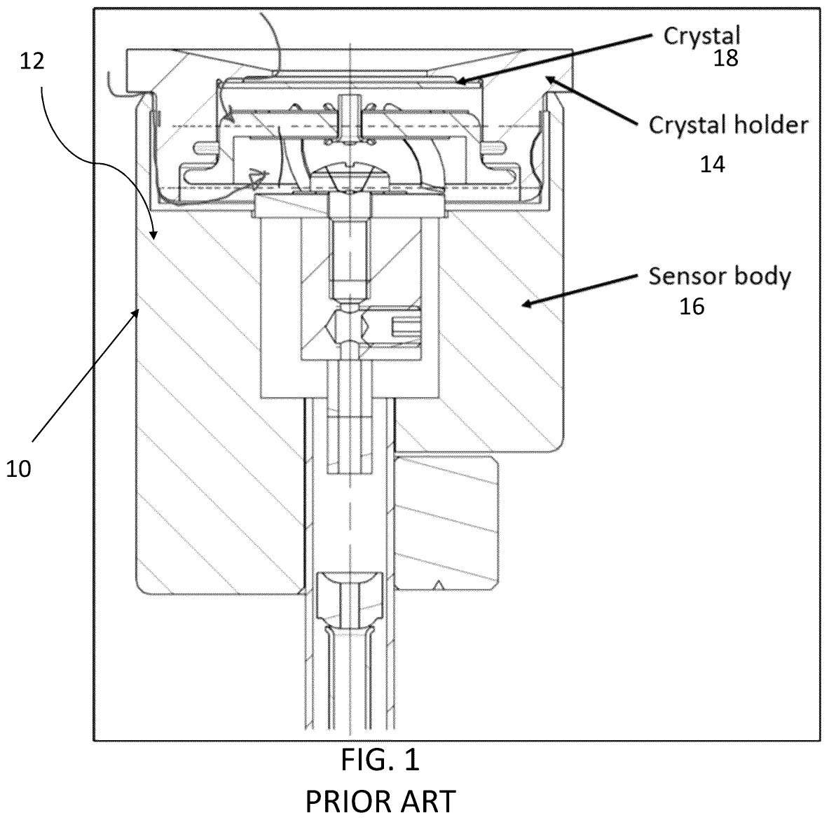

FIG. 1 illustrates in cross-sectional view a conventional QCM sensor commercially available on the marketplace. The QCM sensor 10 includes a sensor housing 12 having a number of housing components, namely a crystal holder 14 and a sensor body 16 to which the crystal holder 14 is coupled. Supported within the crystal holder 14 is a quartz crystal oscillator or plate 18. The quartz crystal plate 18 is sandwiched between electrodes (for example, vapor deposited electrodes) on each side of the quartz crystal plate 18. In accordance with the prior art QCM sensor 10, tight tolerances may be created between the quartz crystal plate 18 and the components of the sensor housing 12 to prevent deposits from entering inside the sensor body 16. In some applications, an O-ring seal may be compressed onto the quartz crystal plate 18. However, manufacturing the components of the QCM sensor 10 with tight tolerances is costly and even the tightest of tolerances still provide a path for process chemicals to travel to the inside of the sensor body 16. Compressing an O-Ring on the quartz crystal plate 18 is very difficult to achieve because the plate 18 is extremely thin and brittle so it is difficult to provide enough force to the crystal to compress the O-Ring without fracturing the plate 18. The arrows indicated in FIG. 1 illustrate potential pathways for process chemicals and/or other contaminants to reach the inside of the sensor body 16 of the prior art QCM sensor 10 with or without an O-ring.

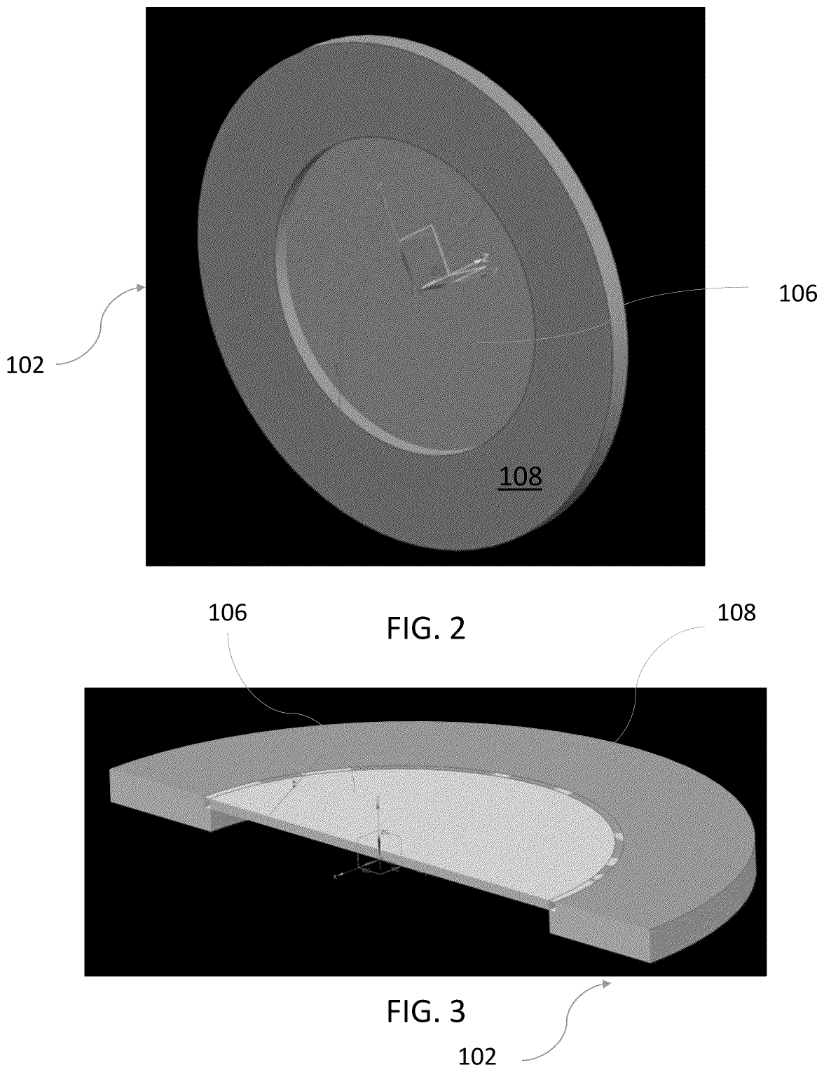

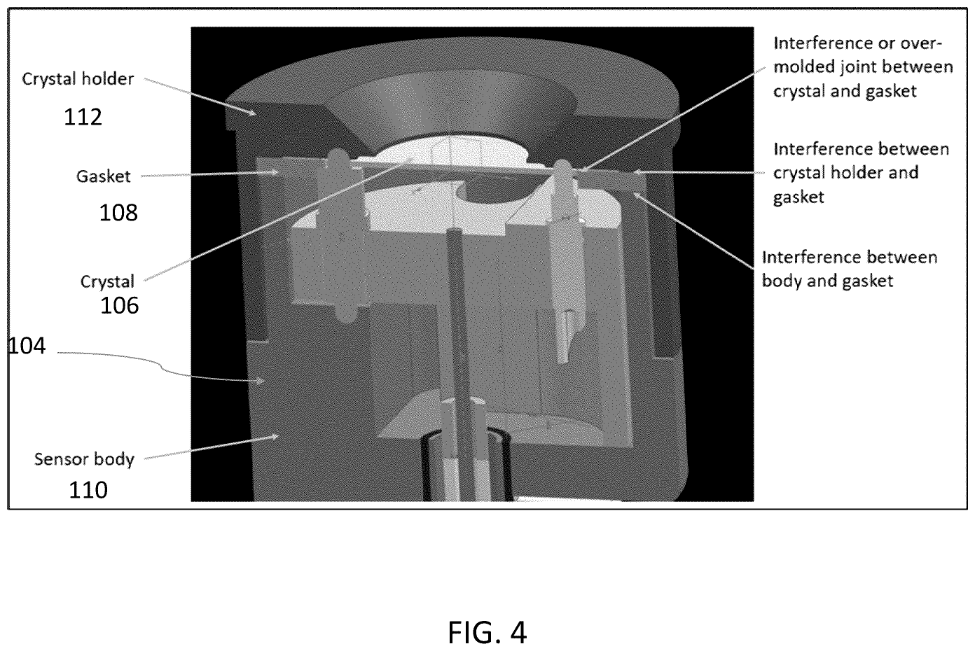

FIGS. 2-4 illustrate a QCM sensor in accordance with the principles of the present disclosure. The QCM sensor 100 includes a crystal seal component 102 (FIGS. 2 and 3) which is supported within a sensor housing 104 of the QCM sensor 100. The crystal seal component 102 includes a quartz crystal plate or substrate 106 (i.e., the oscillating plate) and a gasket seal 108 disposed about the periphery of the quartz crystal substrate 106. In some embodiments, as shown in FIG. 4, the gasket seal 108 may seal against the ingress of fluids through multiple pathways and form a first interference fit or overmolded joint between the crystal 106 and the gasket seal, a second interference fit between the crystal holder 112 and the gasket seal, and a third interference fit between the sensor body 110 and the gasket seal. The gasket seal 108 may be formed of any suitable elastomeric material including, without limitation, natural rubber, synthetic polyisoprene, nitrile rubber, ethylene propylene rubber, polyacrylic rubber, silicone rubber, fluor silicone rubber, fluor elastomers, perfluoro elastomers, polyether block amides, thermoplastic elastomers, thermoplastic vulcanizers, thermoplastic polyurethane, thermoplastic olefins, resilin, elastin, and polysulfide rubber, and/or combinations thereof etc.

In some embodiments, the gasket seal may be made of perfluoroelastomer (FFKM), such as Kalrez® branded materials offered by DuPont de Nemours, Inc., and Chemraz® branded materials offered by Greene Tweed Technologies, Inc., which are both heat resistant and chemically resistant to corrosive chemicals in the process environment in many applications for QCM sensors, including in the semiconductor manufacturing industry. Such materials allow heating of the QM sensor without degradation to the sealing element and with very minimal outgassing.

In some embodiments, the gasket seal 108 is attached to the outer periphery of the crystal substrate 106. In illustrative embodiments, the gasket seal 108 may be overmolded onto the crystal substrate 106 via known overmolding techniques. Overmolding is an injection technique where a single component is manufactured using two or more combinations of materials. In other embodiments, the gasket seal 108 is secured via an interference fit between the outer diameter of the crystal substrate 106 and the inner diameter of the gasket 108. In other embodiments, the gasket seal 108 may be formed into its donut shape and subsequently secured to the crystal substrate 106 with the use of adhesives. In other embodiments, the gasket seal 108 may include two seal components, one disposed on one side of the crystal substrate 106 and the other disposed on the opposing side of the crystal substrate 106.

In embodiments, the gasket seal 108 of the crystal seal component 102 may extend from both the front and rear (i.e., the opposing) faces of the crystal substrate 106. (FIGS. 2 and 3). The gasket seal 108 creates a substantially fluid tight seal about the crystal substrate 106 including about the periphery of the crystal substrate 106. In some embodiments, the gasket seal 108 is compressed between the sensor body 110 and the crystal holder 112 of the sensor housing 104. More specifically, the gasket seal 108 is subjected to opposing compressive forces via the sensor body 110 and the crystal holder 112. The gasket seal 108 prevents passage of processing, deposition fluid or other contaminants from the outer face of the crystal substrate 106 and into the sensor body 110 thus obviating the disadvantages of current QCM sensors discussed hereinabove. In certain embodiments, the extension of the gasket seal 108 from both opposing sides of the crystal substrate 106 increases the amount of “sealing surface area” between the components of the sensor housing 104, particularly, but not necessarily, in a compressed state thereby further enhancing the sealing relation about the crystal substrate 106. By way of example, the gasket seal 108 forms a seal against, and establishes a sealing relation with, the crystal holder 112, with the sensor body 110 and with the crystal substrate 106. In some embodiments, the design allows for the application of an overall protective coating to further insulate the QCM after the QCM has been installed in the sensor. Polymer materials may be used as coating materials of QCM devices due to their relative ease of synthesis and viscoelastic properties. Generally, ceramics, oxides or nitrides, may also be used as coatings. Metal nitride thin films provide high thermal stability, chemical resistance and mechanical properties. Metal nitride coatings are wear resistant, inert and reduce frictions. Metal oxide thin films have high mechanical strength and stiffness, high electrical conductivity, high thermal stability, and high optical transparency in the visible and near infrared regions. These properties vary depending on the particular metal oxide and coating conditions. Various deposition techniques allow for a different structural formation on the surface of the devices. Such coating may be single or multi-layered and may be comprised of chemically resistant materials that may exist in the process environment. In some embodiments the protective coating may comprise silica (silicon dioxide), alumina (aluminum oxide), or a combination of silica and alumina.

In embodiments, the crystal seal component 102 including the crystal substrate 106 and the gasket seal 108 is designed in a manner to minimize force exerted on the crystal substrate 106. In certain embodiments, the gasket seal 108 comprises a relatively soft elastomer to achieve this purpose. In some embodiments, the gasket seal 108 is compressed between the sensor body 110 and the crystal holder 112 and the crystal substrate 106 is substantially removed from these forces, e.g., spaced from the respective connection locations of the gasket seal 108 with the sensor body 110 and the crystal holder 112. Thus, the crystal substrate 106 is subject to minimal and, in embodiments, possibly no axial forces. This minimizes the potential for breakage of the crystal substrate 106 which is an issue with conventional QCM sensors as described hereinabove. In some embodiments, the elasticity of the wrap-around sealing material helps to absorb any vibration that could arise from sources such as adjacent equipment, such as pumps, where the vibration may be transmitted through the sensor body. This vibration reduction assists in eliminating induced frequency shift increasing the signal-to-noise ratio of the sensor.

In accordance with other features, the crystal seal component 102 including the integrally coupled crystal substrate 106 and gasket seal 108, facilitates manufacture of the QCM sensor 100, and also facilitates replacement of a damaged crystal plate. Moreover, it is contemplated that the crystal seal component 102 may be a “stand-alone” component adapted as a replacement part for existing QCM sensors with damaged or malfunctioning crystal plates.

In embodiments, the principles of the present disclosure may be used with other sensor types with oscillating component substrate materials.

### 6. CONCLUSION

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

While embodiments of the present disclosure have been particularly shown and described with reference to certain examples and features, it will be understood by one skilled in the art that various changes in detail may be effected therein without departing from the spirit and scope of the present disclosure as defined by claims that can be supported by the written description and drawings. Further, where exemplary embodiments are described with reference to a certain number of elements it will be understood that the exemplary embodiments can be practiced utilizing either less than or more than the certain number of elements.

What is claimed is:

1. A quartz crystal microbalance (QCM) sensor, which comprises:
a sensor housing; and
a crystal component supported within the sensor housing, the crystal component including a quartz crystal substrate and a gasket seal disposed about the periphery of the quartz crystal substrate configured to prevent ingress of fluids into the sensor housing.

2. The quartz crystal microbalance (QCM) sensor according to claim 1 wherein the sensor housing includes:
a crystal holder for at least partially supporting the crystal component; and
a sensor body coupled to the crystal holder;
wherein the gasket seal is disposed between the crystal holder and the sensor body.

3. The quartz crystal microbalance (QCM) sensor according to claim 2 wherein the crystal substrate is spaced from coupling locations of the gasket seal and the crystal holder and the sensor body.

4. The quartz crystal microbalance (QCM) sensor according to claim 1 wherein the sensor gasket seal is overmolded onto the crystal substrate.

5. The quartz crystal microbalance (QCM) sensor according to claim 2 wherein at least one of the sensor body, crystal holder and gasket seal are configured to establish an interference fit to facilitate formation of a seal within the sensor housing.

6. The quartz crystal microbalance (QCM) sensor according to claim 1 wherein the gasket seal if comprised of a perfluoroelastomer material selected to withstand the temperature parameters of a process environment.

7. The quartz crystal microbalance (QCM) sensor according to claim 6 wherein the perfluoroelastomer material is selected to be chemically resistant to corrosive elements present in the process environment.

8. The quartz crystal microbalance (QCM) sensor according to claim 1 wherein the gasket seal isolates the crystal component from external vibration sources in a process environment.

9. The quartz crystal microbalance (QCM) sensor according to claim 2 wherein the crystal holder is coated with a chemically resistant protective coating.

10. The quartz crystal microbalance (QCM) sensor according to claim 9 wherein the protective coating comprises silica, alumina, or a combination of silica and alumina.

11. The quartz crystal microbalance (QCM) sensor according to claim 1 wherein the gasket seal resists the ingress of fluids through multiple pathways by forming a first interference fit between the crystal and the gasket seal, a second interference fit between the crystal holder and the gasket seal, and a third interference fit between the sensor body and the gasket seal.
